(19) United States
(12) Patent Application Publication
(10) Pub. No.: US 2009/0074078 A1
(43) Pub. Date: Mar. 19, 2009

(54) MOVING IMAGE REPRODUCTION DEVICE

(76) Inventors: Tomoyuki Yamamoto, Chiba (JP); Maki Takahashi, Hiroshima (JP)

Correspondence Address: BIRCH STEWART KOLASCH & BIRCH, PO BOX 747, FALLS CHURCH, VA, 22040-0747, US

(21) Appl. No.: 11/911,332

(22) PCT Filed: Feb. 23, 2006
(86) PCT No.: PCT/JP2006/303221

§ 371 Date: Oct. 11, 2007

(30) Foreign Application Priority Data
Apr. 13, 2005 (JP) 2005-115335

(51) Int. Cl. H04N 11/02

(52) U.S. Cl. 375/240.25; 375/E07.027

(57) ABSTRACT

When an abnormality detected by abnormality detection means is a predetermined abnormality, list correction means corrects a reference list used for enabling access to be made to a decoded frame stored in storage means and used as a reference image. In the case where an n-th frame is a frame decoded using another frame, frame decoding means decodes the n-th frame using a decoded frame which is a reference image stored in the storage means and is accessible by means of the reference list when the n-th frame is decoded, based on header information of the n-th frame.

### TECHNICAL FIELD

The present invention relates to a moving image reproduction device having encoded data error resilience.

### BACKGROUND ART

Regarding a moving image reproduction device which decodes encoded data such as MPEG data, Japanese Patent Laying-Open No. 06-098313 (Patent Document 1) discloses a conventional art with resilience against absence or the like of encoded data. According to the art, when an abnormality occurs in a process of decoding an image due to absence of encoded data or a bit error during transmission, an image which has been decoded is used to replenish a portion of the image where the abnormality occurs in the decoding process. In the following, a configuration and operation of a moving image reproduction device using this art will be described.

FIG. 9 shows a block diagram of a moving image reproduction device using the art. In FIG. 9, the moving image reproduction device includes a header decoding unit 51 decoding encoded data and generating header information, an image decoding unit 52 using the encoded data, header information and a reference image to restructure an image, an image absence detection unit 57 using the header information to detect absence of an image, an image correction unit 55 generating the missing image when the absence of the image is detected, and an image memory 56 holding a decoded image and displaying the image on an external display (not shown) at a predetermined timing.

According to the art, the header information refers to a set of parameters added for each image when a moving image is encoded. The header information includes information necessary for decoding encoded data into an image. Examples of the parameters included in the header information are frame number, image size and quantization parameter for example. The frame number is a parameter used for detecting a missing image, and has the characteristic that the number increases by a certain value in order of decoding images.

With the above-described characteristic, a difference between respective frame numbers corresponding to two images is examined, and accordingly the number of images that should be present between the two images can be known. In the following, an image having a frame number of a numeral N is referred to as frame N.

FIG. 10 shows a procedure of decoding a moving image that is encoded according to the art. With reference to FIGS. 9 and 10, the art will be described. In the following, it is supposed that a frame M and a frame N (M and N are both positive integers and M<N) are two images that are successively input to the moving image reproduction device, and a description will be given of a procedure of decoding frame N by the moving image reproduction device. Here, frame M is an image having been decoded.

In step (hereinafter abbreviated as S) 51, header decoding unit 51 decodes header information from encoded data. In subsequent S52, image absence detection unit 57 examines a difference in number between frame number N and frame number M which is previously input and decoded. If there is the relation N−M=1, it is determined that no image is missing between frames M and N and the procedure proceeds to S54. If the relation N−M=1 is not satisfied, it is determined that any image is missing between frames M and N and the procedure proceeds to S53. In S53, image correction unit 55 replicates an image which is displayed latest among images stored in image memory 56, and replaces the missing image between frames M and N with the replicated image to replenish the missing image between frames M and N.

In S54, based on the header information decoded by header decoding unit 51, image decoding unit 52 decodes, from the encoded data, predicted residual data and a motion vector. Then, the predicted residual data, motion vector as well as an image in image memory 56 are used to decode frame N, and the procedure proceeds to S55. In S55, frame N decoded in S54 is added to and recorded in image memory 56, and is displayed at a predetermined timing on an external display (not shown). The common moving image encoding method generates a predicted image which is similar to a partial region of an image to be encoded, from a decoded region or reference image. The difference between the partial region and the predicted image is encoded for use as predicted residual data. When the predicted image is generated from the reference image, a motion vector representing estimated movement of regions each into which the image is divided is used, and this method is called motion compensation. The method of generating a predicted image using future and past reference images with respect to an image to be encoded in order of display is called bidirectional prediction.

As described above, the conventional moving image reproduction device detects absence of an image by determining whether or not the frame number of an image to be decoded and the frame number of the image which is decoded immediately before the image to be decoded are successive numbers. When absence of an image is detected, the image which is displayed latest among images stored in image memory 56 is replicated, and the missing image between the frames is replaced with the replicated image to replenish the missing image between the frames. When the subsequent image is decoded, if the missing image is necessary to use as a reference image, the image replenishing the missing image can be used instead. Therefore, a moving image can be reproduced without failure in the decoding process due to the shortage of the reference image because of the absence of an image.
Patent Document 1: Japanese Patent Laying-Open No. 06-098313

### DISCLOSURE OF THE INVENTION

### Problems to be Solved by the Invention

According to the above-described conventional art, respective frame numbers of two images that are decoded successively are examined to detect an abnormality during decoding. However, the abnormality which is detected based on the fact that respective frame numbers of two successively decoded images are nonconsecutive numbers is not always absence of an image due to absence of encoded data. The frame numbers are also nonconsecutive in the case where a decode error occurs that is an error of a frame number decoded differently from the original number due to a bit error included in encoded data that is caused by a transmission error. The conventional moving image reproduction device, however, determines that an image is missing even when the decode error of the frame number occurs, and replenishes the missing image using a reference image in the image memory. Here, the following two problems arise to deteriorate the quality of a reproduced image.

The first problem is that, when the frame number is used to determine the order of displaying images, the images are displayed at timings different from original ones. Here, one example is considered in which an error occurs in encoded data of a moving image composed of frames 1 to 20 and a decode error occurs to cause frame 10 to be decoded as frame 100. It is supposed here that the order of displaying images and the order of decoding images are identical to each other.

In the case where encoded data including a bit error is input to the conventional moving image reproduction device, frames 1 to 9 are displayed first at original timings. Then, while the moving image reproduction device decodes frame 10, the moving image reproduction device determines that the image of frame 10 is the image of frame 100 because of the decode error. The moving image reproduction device thus determines that frames 10 to 99 are missing and replicates images from the image which is displayed latest among images stored in image memory 56 to store the replicated images in image memory 56. The images are then successively displayed. After all of frames 10 to 99 are displayed, frame 100 is displayed. In other words, the image which should be originally displayed as the tenth image is displayed as the 100-th image. Further, frames 11 to 20 following frame 10 having the decode error are also displayed as 101-th to 120-th frames.

The second problem is that, when the image subsequent to the image having a decode error is to be decoded, a reference image necessary for decoding is not present in the image memory. This problem occurs in the case where a moving image is reproduced that is encoded by the encoding method that can use a plurality of reference images for motion compensation. This problem will be described in detail with reference to FIG. 11.

FIG. 11 (a) shows a state where the moving image reproduction device operates normally in decoding encoded data without bit error and absence. Here, it is supposed that four images can be recorded in the image memory. It is also supported that, for decoding an image, four images that are decoded immediately before the image are used as reference images. In other words, in FIG. 11 (a), frames 2 to 5 in the image memory are used for decoding frame 6.

FIG. 11 (b) shows a state of the moving image reproduction device in the case where frame 6 of FIG. 11 (a) is decoded as frame 8 due to a decode error. In order to decode frame 8, frames 4 to 7 are necessary. In the state of FIG. 11 (b), however, frames 6 and 7 are not in the image memory. Then, the conventional moving image reproduction device displays frames 2 and 3 as shown in FIG. 11 (c) and thus deletes frames 2 and 3 from the image memory. The device then generates frames 6 and 7 from frame 5 and adds the frames to the image memory instead of frames 2 and 3, and stores the frames in the memory. When the image memory is in the state shown in FIG. 11 (c), frame 8 can be decoded.

In the state of FIG. 11 (c), frame 8 is decoded and added to the image memory. Then, frame 4 is displayed as shown in FIG. 11 (d). In the state of FIG. 11 (d), the image to be decoded next is frame 7. In decoding frame 7, frames 3 to 6 are necessary as shown in FIG. 11 (e). However, in the state of FIG. 11 (d), frames 3 and 4 are output from the image memory and have already been displayed, and thus the frames are not in the image memory. As a result, the decoding quality of frame 7 considerably deteriorates.

As described above, when a decode error occurs in the frame number, the conventional moving image reproduction device has the problem that decoded images are displayed in the order different from the original one, as well as the problem that, when the image following the image having a decode error is to be decoded, a part of reference images is not present in the image memory. The resultant problem is that the quality of the reproduced moving image deteriorates.

The present invention has been made in view of the above-described conditions, and an object of the invention is to provide a moving image reproduction device having encoded data error resilience that can display images in the original display order even if a decode error occurs in the frame number which is used for detecting absence of an image, and that can reproduce an image with high quality even when a part of reference images which are necessary for decoding the image is not in the image memory.

### Means for Solving the Problems

In order to solve the above-described problems, in accordance with an aspect of the present invention, a moving image reproduction device reproduces a moving image composed of a plurality of frames by decoding encoded data of the moving image, and the device includes: header information decoding means for successively decoding header information of the plurality of frames each from the encoded data; frame decoding means for successively decoding the plurality of frames; storage means for allowing successive storage of a predetermined number of decoded frames that are decoded by the frame decoding means; abnormality detection means for detecting whether or not there is an abnormality relating to a frame, based on at least two pieces of header information including the header information of an n (natural number of at least two)-th frame that are decoded by the header information decoding means; list generation means for generating a reference list for allowing the frame decoding means to access a decoded frame stored in the storage means and used as a reference image, by associating the header information of each of at least one decoded frame stored in the storage means with a storage address of each of the at least one decoded frame; and list correction means for correcting the reference list when the abnormality detected by the abnormality detection means is a predetermined abnormality. When the n-th frame is a frame decoded using another frame, the frame decoding means decodes the n-th frame using a decoded frame that is stored in the storage means and used as the reference image and that is accessible by means of the reference list when the n-th frame is decoded, based on the header information of the n-th frame.

Preferably, the plurality of frames are in order of being decoded by the frame decoding means.

Preferably, the header information includes a frame number for identifying a frame, and the list generation means generates the reference list for allowing the frame decoding means to access a decoded frame stored in the storage means and used as a reference image, by associating the frame number of each of the at least one decoded frame stored in the storage means with the storage address of each of the at least one decoded frame.

Preferably, the header information includes a frame number for identifying a frame, the predetermined abnormality is an abnormality that a decoded frame used as the reference image by the frame decoding means when the frame decoding means decodes the n-th frame is not stored in the storage means, and the list correction means corrects the reference list, when the abnormality detected by the abnormality detection means is the predetermined abnormality, by associating the frame number of the decoded frame used as the reference image with the storage address of a frame that is included in the at least one decoded frame stored in the storage means and that is used latest for display.

Preferably, the header information includes a frame number for identifying a frame, the predetermined abnormality is an abnormality that a decoded frame used as the reference image by the frame decoding means when the frame decoding means decodes the n-th frame is not stored in the storage means, and the list correction means corrects the reference list, when the abnormality detected by the abnormality detection means is the predetermined abnormality, by associating the frame number of the decoded frame used as the reference image with the storage address of a frame that is included in the at least one decoded frame stored in the storage means and that is closest to the decoded frame used as the reference image in terms of order of use for display.

Preferably, the header information includes a frame number for identifying a frame, the abnormality detection means determines whether or not there is a missing frame based on three frame numbers corresponding respectively to at least three successive frames including the n-th frame, and the moving image reproduction device further includes replenishment means for replenishing, when the abnormality detection means determines there is a missing frame, the missing frame by replicating a frame that is included in the at least one decoded frame stored in the storage means and used as the reference image by the frame decoding means and that is used latest for display.

Preferably, the header information includes a frame number for identifying a frame, the abnormality detection means determines whether or not there is a missing frame based on three frame numbers corresponding respectively to at least three successive frames including the n-th frame, and when the abnormality detection means determines there is a missing frame, the replenishment means replenishes the missing frame by replicating a frame that is included in the at least one decoded frame stored in the storage means and used as the reference image by the frame decoding means and that is closest to the missing frame in terms of order of use for display.

Preferably, the header information includes a frame number for identifying a frame, and the abnormality detection means determines, based on three frame numbers corresponding respectively to at least three successive frames including the n-th frame, whether or not there is a decoded frame among the three frames that is stored in the storage means and having an erroneous frame number.

Preferably, the device further includes number correction means for correcting, when the abnormality detection means determines that there is the decoded frame having the erroneous frame number, the erroneous frame number of the decoded frame, based on the frame number of a frame without an error among the three frames.

Preferably, the header information includes a frame number for identifying a frame, the plurality of frames include a plurality of reference frames used as the reference image by the frame decoding means, and the abnormality detection means detects whether or not there is an abnormality relating to a frame, based on the frame number corresponding to the n-th frame decoded by the frame decoding means, the frame number corresponding to an (n−1)-th frame decoded by the frame decoding means and the frame number corresponding to a reference frame second closest to the n-th frame, among a plurality of the reference frames decoded by the frame decoding means.

Preferably, the abnormality detected by the abnormality detection means is an abnormality that a decoded frame used as the reference image by the frame decoding means when the frame decoding means decodes the n-th frame is not stored in the storage means, and when there is the abnormality that a decoded frame used as the reference image is not stored in the storage means, the list correction means corrects the reference list by associating the frame number of the decoded frame used as the reference image with a storage address of a frame that is included in the at least one decoded frame stored in the storage means and that is used latest for display.

Preferably, the abnormality detected by the abnormality detection means is an abnormality that there is a missing frame, and the moving image reproduction device further includes replenishment means for replenishing, when the abnormality detection means determines there is a missing frame, the missing frame by replicating a frame that is included in the at least one decoded frame stored in the storage means and used as the reference image by the frame decoding means, and that is used latest for display.

Preferably, the abnormality detected by the abnormality detection means is an abnormality that there is a decoded frame having an erroneous frame number, and the moving image reproduction device further includes number correction means for correcting, when there is the decoded frame having the erroneous frame number, the erroneous frame number of the decoded frame based on the frame number of a frame without error, among the frame number of the n-th frame, the frame number of the (n−1)-th frame and the frame number of the reference frame that is second closest to the n-th frame.

### EFFECTS OF THE INVENTION

The moving image reproduction device of the present invention can display images in the original display order even if a decode error of the frame number used for detecting absence of an image occurs. Further, since there is not the problem of deterioration in image quality due to absence in an image memory of a part of a reference image necessary for decoding an image, the image of good quality can be reproduced.

### BRIEF DESCRIPTION OF THE DRAWINGS

FIG. 1 is a block configuration diagram of a moving image reproduction device according to first and second embodiments.

FIG. 2 is a block configuration diagram of a decode abnormality detection unit according to the first and second embodiments.

FIG. 3 is a block configuration diagram of a reference image list generation unit according to the first and second embodiments.

FIG. 4 is an operational flowchart of the moving image reproduction device according to the first embodiment.

FIG. 5 illustrates a method of correcting a reference image list according to the present invention.

FIG. 6 illustrates a method of correcting a reference image list of the present invention in the case where a bidirectional predicted image is present.

FIG. 7 illustrates definitions of symbols used for illustrating the second embodiment.

FIG. 8 is an operational flowchart of the moving image reproduction device according to the second embodiment.

FIG. 9 is a block configurational diagram of a moving image reproduction device according to a conventional art.

FIG. 10 is an operational flowchart of the moving image reproduction device according to the conventional art.

FIG. 11 illustrates a problem of the conventional art.

### DESCRIPTION OF THE REFERENCE SIGNS

1 header decoding unit, 2 image decoding unit, 3 decode abnormality detection unit, 4 reference image list generation unit 5 image correction unit, 6 image memory, 8 frame number holding unit, 9 held frame number update unit, 10 image absence possibility detection unit, 11 image absence determination unit, 12 decode error determination unit, 13 reference image list, 14 reference image storage address acquisition unit, 15 reference image list production unit, 16 reference image list correction unit, 57 image absence detection unit

### BEST MODES FOR CARRYING OUT THE INVENTION

### First Embodiment

In the following, a description will be given of a moving image reproduction device according to a first embodiment of the present invention. In the following description, it is supposed that frames L, M, N are input in this order to the moving image reproduction device and that an image to be decoded is frame N. A moving image reproduced by the moving image reproduction device is composed of a plurality of frames.

FIG. 1 shows moving image reproduction device 1000 in the present embodiment. In FIG. 1, moving image reproduction device 1000 in the first embodiment includes a header decoding unit 1 decoding encoded data to generate header information, an image decoding unit 2 using the encoded data, header information and a reference image to restructure an image, a decode abnormality detection unit 3 holding three frame numbers corresponding respectively to frames L, M, N and, based on the three frame numbers as held, detects whether or not there is absence of an image between frames L and M, detects whether or not there is a possibility of absence of an image between frames M and N, and detects whether or not there is a decode error of the frame number of frame M, an image correction unit 5 generating an image for an absent image when absence of the image is detected, an image memory 6 holding a decoded image and displaying the image on an external display (not shown) at a predetermined timing, and a reference image list generation unit 4 generating a reference image list that is a list allowing image decoding unit 2 to access a reference image in image memory 6, and holding the reference image list.

Specifically, header decoding unit 1 successively decodes, from encoded data, header information of a plurality of frames each. Image decoding unit 2 successively decodes a plurality of frames. Image memory 6 is a memory that can successively store a predetermined number (four for example) of decoded frames having been decoded by image decoding unit 2.

Decode abnormality detection unit 3 determines, based on three frame numbers corresponding respectively to at least three successive frames including frame N (n-th frame), whether or not there is absence of a frame. Further, decode abnormality detection unit 3 determines whether or not image memory 6 stores a decoded frame that is a reference image used by image decoding unit 2 when image decoding unit 2 decodes frame N (n-th frame). Furthermore, decode abnormality detection unit 3 determines, based on three frame numbers corresponding respectively to at least three successive frames including frame N (n-th frame), whether or not any of the three frames is a decoded frame that is stored in image memory 6 and that has a mistake (error) of the frame number.

Reference image list generation unit 4 associates the frame number of each of at least one decoded frame stored in image memory 6 with the storage address of each of at least one decoded frame to generate a reference image list for allowing image decoding unit 2 to access a decoded frame stored in image memory 6 and used as a reference image.

In the case where frame N (n-th frame) is a frame decoded using another frame, image decoding unit 2 decodes frame N, based on the header information of frame N, using a decoded frame which is stored in image memory 6 and used as a reference image and accessible by means of the reference image list when frame N is decoded. The header information of frame N includes information (such as frame number of a reference image for decoding frame N) necessary for decoding an image from encoded data.

A detailed description will be given of decode abnormality detection unit 3 and reference image list generation unit 4 that are characteristic components of moving image reproduction device 1000 according to the present embodiment.

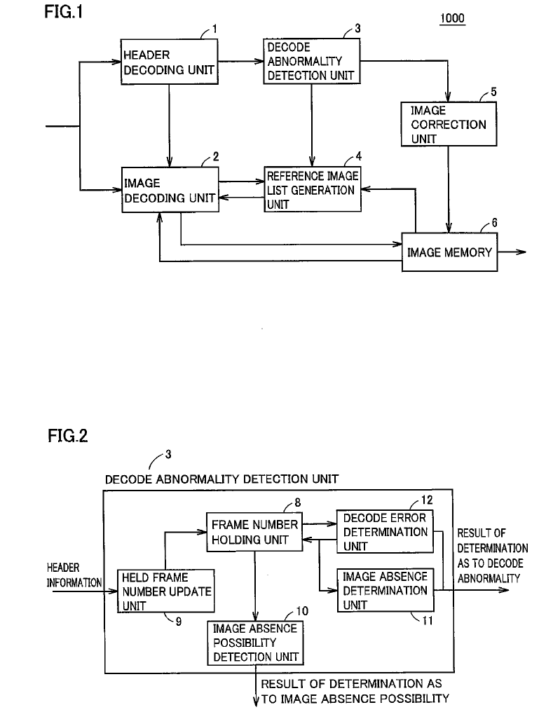

FIG. 2 shows a block diagram of decode abnormality detection unit 3. As shown in FIG. 2, decode abnormality detection unit 3 includes a frame number holding unit 8 holding respective frame numbers of frames L to N, a held frame number update unit 9, an image absence possibility detection unit 10 detecting whether or not there is a possibility of absence of an image between frames M and N, based on the hold frame numbers, an image absence determination unit 11 determining whether or not there is absence of an image between frames L and M, and a decode error determination unit 12 determining whether or not a decode error of the frame number of frame M occurs.

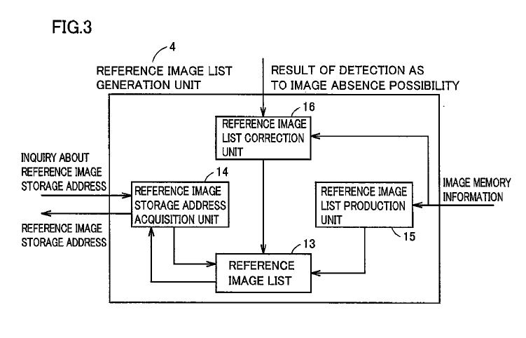

FIG. 3 shows a block diagram of reference image list generation unit 4. As shown in FIG. 3, reference image list generation unit 4 includes a reference image list 13 which is a list associating the frame number of a reference image with the storage address of the reference image in image memory 6, a reference image storage address acquisition unit 14 receiving a frame number as an input and outputting the storage address in image memory 6 of the associated reference image, a reference image list production unit 15 producing reference image list 13 by associating the frame number corresponding to each reference image present in image memory 6 with the storage address in the image memory of the reference image, and a reference image list correction unit 16 correcting reference image list 13 when the result of detection that there is a possibility of absence of an image is input.

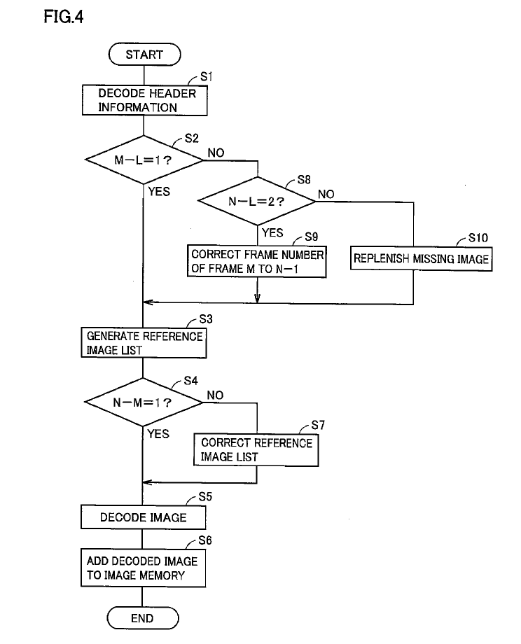

Operation of the moving image reproduction device in the present embodiment will be described with reference to FIG. 4. In the present embodiment, decode abnormality detection unit 3 determines whether or not there is absence of an image between frames L and M, determines whether or not there is a possibility of absence of an image between frames M and N, and determines whether or not a decode error of the frame number of frame M occurs. Based on these determinations, decode abnormality detection unit 3 detects the following first to fourth cases.

The first case is the case where the relations N−M=1 and M−L=1 are satisfied and there is no absence of an image between frames L and N and no decode error of the frame number of frame M.

The second case is the case where N−M is any other than one and the relation M−L=1 is satisfied and it is determined that there is a possibility of absence of an image between frames M and N.

The third case is the case where N−L is any other than two and M−L is any other than one and it is determined that there is absence of an image between frames L and M.

The fourth case is the case where the relation N−L=2 is satisfied and M−L is any other than one and it is determined that a decode error of the frame number of frame M occurs.

Depending on the result of detection by decode abnormality detection unit 3, the operation of the moving image reproduction device in the present embodiment is different. In the following, a process flow of the operation performed according to each result of detection by decode abnormality detection unit 3 will be described with reference to FIG. 4.

In the first case, in S1, header decoding unit 1 decodes header information from input encoded data. The process then proceeds to S2 in which decode abnormality detection unit 3 calculates M−L in order to determine whether or not there is a possibility of absence of an image between frames L and M. In the first case, the result is YES since the relation M−L=1 is satisfied. Then, it is determined that there is no possibility of absence of an image between frames L and M or there is no possibility of a decode error of the frame number of frame M, and the process proceeds to S3. The step (S8) of detecting whether or not there is absence of an image is not performed. In S3, reference image list generation unit 4 examines image memory 6 to generate a reference image list, and the process proceeds to S4. In S4, decode abnormality detection unit 3 calculates N−M in order to determine whether or not there is a possibility of absence of an image between frames M and N. In the first case, the relation N−M=1 is satisfied and thus the result is YES. It is thus determined that there is no possibility of absence of an image and the process proceeds to S5. In S5, image decoding unit 2 decodes frame N and the process proceeds to S6. In S6, decoded frame N is stored in image memory 6 and displayed at a predetermined timing on an external display (not shown).

In the second case, in S1, header decoding unit 1 decodes header information from input encoded data. The process then proceeds to S2 in which decode abnormality detection unit 3 calculates M−L in order to determine whether or not there is a possibility of absence of an image between frames L and M. In the second case, the result is YES since the relation M−L=1 is satisfied. It is thus determined that there is no possibility of absence of an image between frames L and M or there is no possibility of occurrence of a decode error of the frame number of frame M. The process thus proceeds to S3 and the step (S8) of detecting whether or not there is absence of an image is not performed. In S3, reference image list generation unit 4 examines image memory 6 to generate a reference image list and the process proceeds to S4. In S4, decode abnormality detection unit 3 calculates N−M in order to determine whether or not there is a possibility of absence of an image between frames M and N. In the second case, the result is NO since N−M is any other than one. It is thus determined that there is a possibility of absence of an image and the process proceeds to S7. In S7, reference image list generation unit 4 corrects reference image list 13 and the process proceeds to S5. The method of correcting reference image list 13 will be described hereinlater. In S5, image decoding unit 2 decodes frame N and the process proceeds to S6. In S6, decoded frame N is stored in image memory 6 and displayed at a predetermined timing on an external display (not shown).

In the third case, in S1, header decoding unit 1 decodes header information from input encoded data. The process then proceeds to S2 in which decode abnormality detection unit 3 calculates M−L in order to determine whether or not there is a possibility of absence of an image between frames L and M. In the third case, the result is NO since M−L is any other than one. It is thus determined that there is one of the possibility of absence of an image between frames L and M and the possibility of occurrence of a decode error of the frame number of frame M. The process then proceeds to S8. In S8, decode abnormality detection unit 3 calculates N−L in order to determine whether or not there is absence of an image between frames L and M. In the third case, the result is NO since N−L is any other than two. It is thus determined that there is absence of an image between frames L and M and image correction unit 5 is informed of this. The process then proceeds to S10. In S10, image correction unit 5 replicates an image displayed latest among images stored in image memory 6 and replaces the missing image between frames L and M with the replicated image to replenish the missing image between frames L and M, and the process proceeds to S3.

In S10, image correction unit 5 may replicate the image which is closest to the missing image in terms of the order used for display, among images stored in image memory 6, and replace the missing image between frames L and M with the replicated image to replenish the missing image between frames L and M.

In S3, reference image list generation unit 4 examines image memory 6 to generate a reference image list, and the process proceeds to S4. In S4, decode abnormality detection unit 3 calculates N−M in order to determine whether or not there is a possibility of absence of an image between frames M and N. The result is YES when the relation N−M=1 is satisfied, and it is thus determined that there is no possibility of absence of an image. The process then proceeds to S5. The result is NO when N−M is any other than one and it is thus determined that there is a possibility of absence of an image. The process then proceeds to S7. In S7, reference image list generation unit 4 corrects reference image list 13 and the process proceeds to S5. The method of correcting reference image list 13 will be described hereinlater. In S5, image decoding unit 2 decodes frame N and the process proceeds to S6. In S6, the decoded frame N is stored in image memory 6 and displayed at a predetermined timing on an external display (not shown).

In the fourth case, in S1, header decoding unit 1 decodes header information from input encoded data. The process then proceeds to S2 in which decode abnormality detection unit 3 calculates M−L in order to determine whether or not there is a possibility of absence of an image between frames L and M. In the fourth case, the result is NO since M−L is any other than one. It is thus determined that there is one of the possibility of absence of an image between frames L and M and the possibility of occurrence of a decode error of the frame number of frame M. The process then proceeds to S8. In S8, N−L is calculated in order to determine whether or not there is absence of an image between frames L and M. In the fourth case, the result is YES since the relation N−L=2 is satisfied. It is thus determined that there is no absence of an image between frames L and M and that there is occurrence of a decode error of the frame number of frame M, and the image correction unit 5 is informed of this. The process then proceeds to S9.

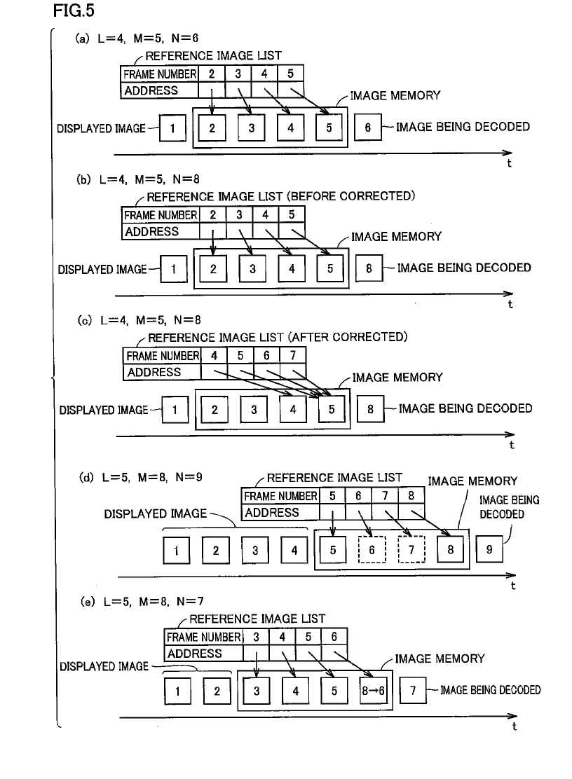

In S9, image correction unit 5 changes the frame number of frame M in image memory 6 to N−1, and the process proceeds to S3. The correction of the frame number is to correct for example the frame number of frame 8 in image memory 6 to 6 as shown in FIG. 5 (e), as described hereinlater. In S3, reference image list generation unit 4 examines image memory 6 to generate a reference image list, and the process proceeds to S4. In S4, decode abnormality detection unit 3 calculates N−M in order to determine whether or not there is a possibility of absence of an image between frames M and N. Since image correction unit 5 changes the frame number of frame M in image memory 6 to N−1 in S9, the relation N−M=1 is satisfied. The result of S4 is thus YES and it is determined that there is no possibility of absence of an image. The process then proceeds to S5. In S5, image decoding unit 2 decodes frame N and the process proceeds to S6. In S6, decoded frame N is stored in image memory 6 and displayed at a predetermined timing on an external display (not shown).

A detailed description will be given of a method of correcting reference image list 13 by reference image list generation unit 4 in S7 of FIG. 4. Reference image list 13 is corrected in the following procedure.

(1) The frame number of a reference image necessary for decoding frame N is estimated. It is supposed that image memory 6 can record four images and an image is decoded using four images as reference images that are decoded immediately before the image to be decoded. Then, frames 2, 3, 4, 5 are necessary for decoding frame 6 as shown in FIG. 5 (a) for example.

(2) Of the reference images necessary for decoding frame N, regarding images in image memory 6, the frame number of the image is associated with the storage address of the image in image memory 6 and they are recorded in reference image list 13.

(3) Of the reference images necessary for decoding frame N, regarding images that are not in image memory 6, the frame number of the image is associated with the storage address in image memory 6 of the image which is displayed latest among images stored in image memory 6 and they are recorded in reference image list 13. Reference image list 13 is corrected in this way.

Using FIG. 5 as an example, the method of correcting reference image list 13 will be described. FIG. 5 (a) shows the states of image memory 6 and reference image list 13 when frame 6 is decoded, under the condition where there is no absence of an image and there is no decode error. In the following description, it is supposed that the number of images that can recorded in image memory 6 is four. Further, it is supposed that, for decoding frame N, four images that are decoded immediately before frame N are used as reference images. For example, in the state of FIG. 5 (a), frames 2 to 5 in image memory 6 are used for decoding frame 6.

FIG. 5 (b) shows the states of image memory 6 and reference image list 13 when the fact that N−M is any other than one is detected in S4 of FIG. 4. Under this condition, frames 6, 7 included in frames 4 to 7 which are necessary for decoding frame 8 are not in image memory 6. Thus, reference image list 13 is corrected by associating the frame numbers of frames 6, 7 in reference image list 13 with the storage address of frame 5 which is a reference image displayed latest. The states of image memory 6 and reference image list 13 after reference image list 13 is corrected is those as shown in FIG. 5 (c).

In the step of correcting reference image list 13 (S7 in FIG. 4), in the case where an image to be used as a reference image is not in the image memory, an image to be used instead is the image displayed latest among images stored in image memory 6. Alternatively, when it is determined that a reference image is not in the image memory, it may be assumed that the reference image is present in the image memory and, an image which is closest in display order to the reference image may be used as the reference image.

Specifically, when an image to be used as a reference image is not stored in the image memory, reference image list generation unit 4 corrects reference image list 13 by associating the frame number of the image (frame) used as the reference image with the storage address of the frame which is closest to the decoded frame to be used as the reference image in terms of the order used for display, among at least one decoded frames stored in image memory 6.

In the case where images are displayed in order of being decoded, “reference image displayed latest” refers to “reference image decoded latest, namely a reference image which is decoded most recently.” “When it is determined that a reference image is not in the image memory, it may be assumed that the reference image is present in the image memory and, an image which is closest in display order to the reference image” should be “image closest to the reference image in order of being decoded in the case where it is assumed that a reference image, for which it is determined that the reference image is not in the image memory, is present in the image memory.” However, unlike the normal condition, if the order of decoding and the order of display are not identical, the result is different. Then, an image which is closest in order of display to the reference image, in the case where it is determined that the reference image is not in the image memory while it is assumed that the reference image is present in the image memory, is used. Then, an excellent reproduced image can be obtained even when the order of decoding and the order of display are not identical.

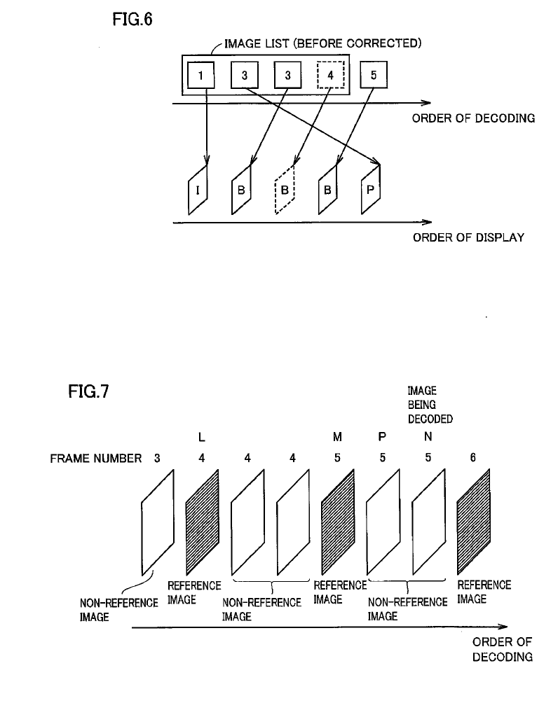

As an example, coded data as shown in FIG. 6 is considered where bidirectional predicted images are present and the order of decoding and the order of display are not identical. In FIG. 6, it is supposed that frame 4 is missing. At this time, the image in the image memory that is displayed latest is frame 2, and the image which is closest in display order to missing frame 4 is frame 3. In this case, frame 3 may be used instead of frame 4 to obtain more excellent reproduced moving image as compared with the case where frame 2 is used instead of frame 4.

A description will be given of a method of replenishing a missing image in S10 of FIG. 4. In this case, as shown in FIG. 5 (d), L, M and N are supposed to be 5, 8 and 9 respectively. In S10, for replenishing the missing (M−L−1) images, the image displayed latest is replicated and added to image memory 6. For example, in the state of FIG. 5 (c), it is supposed that frame 8 is decoded and the next image to be decoded is frame 9. When decoding of frame 9 is started, frames 3 to 5 and 8 are in the image memory. Of these frames, frames 3, 4 are displayed, and frames 6, 7 are replicated from frame 5. Accordingly, the state in FIG. 5 (d) is generated. In the state of FIG. 5 (d), frame 9 can be decoded.

Regarding the method of replenishing a missing image in S10, instead of the method according to which the reference image which is displayed latest in image memory 6 is replicated, a method may be used according to which a reference image in the image memory that is closest to the missing image in terms of display order maybe replicated.

In S9 of FIG. 4, in the case where it is determined that the frame number is in error of the decoded image of frame M which is decoded immediately before frame N to be decoded and recorded in the image memory, the frame number is corrected to N−1. Specifically the frame number of frame 8 in image memory 6 is corrected to 6 (=N−1=7−1) as shown in FIG. 5 (e). Thus, based on the frame number which is not in error, the frame number determined as erroneous is corrected. The present embodiment uses “N” of frame N as the frame number which is not in error, and corrects the frame number of frame M which is decoded immediately before frame N and which is determined as erroneous, to “N−1.” The correction of the frame number is necessary for displaying frame 6 for which a decode error occurs, in the original order and timing.

With the above-described operation, the moving image reproduction device in the present embodiment does not have the problem that an image is not displayed at a correct timing and the problem that the image quality deteriorates due to absence in the image memory of a part of reference images necessary for decoding the image, even when a decode error of the frame number occurs, and can reproduce an image with excellent quality.

These effects are confirmed as follows. It is confirmed whether or not the problems are solved actually, by applying the example of encoded data causing the problem in the conventional art, as described in the section “Problems to be Solved by the Invention” to the operational flowchart of the moving image reproduction device in FIG. 4. The example of encoded data causing the problem in the conventional art refers to the case where encoded data of a moving image composed of frames 1 to 20 has an error occurring therein to cause a decode error so that frame 10 is decoded as frame 100. Here, the order of displaying images and the order of decoding images are identical.

Frames 1 to 9 are normally decoded, and subsequently frame 10 is to be decoded as frame 100 due to a bit error caused in encoded data due to a transmission error. In this case, the order of input to the moving image reproduction device is frame L=8, frame M=9 and frame N=100. In S2 of FIG. 4, the relation M−L=1 is satisfied and thus the process proceeds through S3 to S4. In S4, the relation is N−M=91. Since the difference is other than 1, the result is NO. It is accordingly determined that there is a possibility of absence of images between frames 9 and 100, and the process proceeds to S7 to correct the reference image list. This case corresponds to “the second case” as described above.

As described in detail about “method of correcting reference image list 13 by reference image list generation unit 4 in S7 of FIG. 4,” in this case:

(1) it is supposed that image memory 6 can record four images and an image is decoded using, as reference images, four images that are decoded immediately before the image and thus, frames 96 to 99 are necessary as frame numbers of reference images that are required for decoding frame 100; and

(2) since none of the reference images (frame 96 to frame 99) required for decoding frame 100 is present in image memory 6, frame numbers 96 to 99 of the images are associated with the storage address, in image memory 6, of the image of frame 9 which is displayed latest among images stored in image memory 6, and those associated are recorded in reference image list 13.

Subsequently, in S5, the image of frame 100 is decoded using the image of frame 9 as a reference image. In S6, the decoded image of frame 100 is added to image memory 6.

Then, this is the case where frames 1 to 9 are normally decoded, frame 100 is decoded using frame 9 as a reference image and then frame 11 is to be decoded. In this case, the order of input to the moving image reproduction device is L=9, M=100, N=11. This case corresponds to “the fourth case” as described above.

In S2 of FIG. 4, the relation is M−L=91 and the difference is other than one. Then, the result is NO and it is determined that there is any of a possibility of absence of an image between frames L and M and a possibility of occurrence of a decode error of the frame number of frame M, and the process proceeds to S8. In S8, in order to determine whether or not an image is missing between frames L and M (9 and 100), N−L is calculated. In this case, there is the relation N−L=2 and the result is YES. It is thus determined that there is no absence of an image between frames L and M and a decode error of the frame number of frame M (100) occurs. Image correction unit 5 is informed of this and the process proceeds to S9. In S9, image correction unit 5 changes the frame number of frame M (100) in image memory 6 to N−1 (=10), and the process proceeds to S3.

In S3, reference image list generation unit 4 examines image memory 6 to generate a reference image list and the process proceeds to S4. In S4, decode abnormality detection unit 3 calculates N−M to determine whether or not there is a possibility of absence of an image between frames M and N (10 (corrected from 100) and 11). In S9, image correction unit 5 changes the frame number of frame M in image memory 6 to N−1 and the relation N−M=1 is accordingly satisfied. Thus the result of S4 is YES and it is determined that there is no possibility of absence of an image, and the process proceeds to S5. In S5, image decoding unit 2 decodes frame N and the process proceeds to S6. In S6, the decoded frame N is stored in image memory 6 and displayed at a predetermined timing on an external display (not shown).

As described above, while frame 10 is temporarily decoded as frame 100 because of inclusion of a bit error in the encoded data due to a transmission error, the frame number is corrected to frame 10 which is the correct frame number, when frame 11 is subsequently decoded. Thus, it can be understood that the problems to be solved by the conventional art: “when the frame number is used to determine the order of displaying images, the images are displayed at timings different from original ones” and “when the image subsequent to the image having a decode error is to be decoded, a reference image necessary for decoding is not present in the image memory and thus decode quality is considerably deteriorated” are all solved. Further, the operational flowchart of the moving image reproduction device shown in FIG. 4 may be applied to the frame number and the header information of images decoded one after another, it can be detected whether or not there is an image relevant to a decoded image stored in the image memory, and any decode abnormality which is a decode error of the header information relevant to the image can be detected.

It is supposed that there is encoded data of a moving image composed of frames 1 to 200, and frames 1 to 9 are normally decoded while encoded data of the moving image composed of frames 10 to 99 are actually missing. This case is applied to the operational flowchart of the moving image reproduction device of FIG. 4 to confirm whether or not the problems are actually solved. It is supposed here that the order of display and the order of decoding are identical.

After frame 9 is decoded, frames 10 to 99 are actually missing and frame 100 is to be decoded. In this case, the order of input to the moving image reproduction device is frame L=8, M=9, N=100. In S2 of FIG. 4, the relation M−L=1 is satisfied and the process proceeds through S3 to S4. In S4, the relation is N−M=91 and the difference is other than one. The result is thus NO and it is determined that there is a possibility of absence of an image between frames 9 and 100. The process then proceeds to S7 and the reference image list is corrected. This case corresponds to “the second case” described above.

As described in detail about “method of correcting reference image list 13 by reference image list generation unit 4 in S7 of FIG. 4,” in this case:

(1) it is supposed that image memory 6 can record four images and an image is decoded using, as reference images, four images that are decoded immediately before the image and thus, frames 96 to 99 are necessary as frame numbers of reference images that are required for decoding frame 100; and

(2) since none of the reference images (frame 96 to frame 99) required for decoding frame 100 is present in image memory 6, frame numbers 96 to 99 of the images are associated with the storage address, in image memory 6, of the image of frame 9 which is displayed latest among images stored in image memory 6, and those associated are recorded in reference image list 13.

Subsequently, in S5, the image of frame 100 is decoded using the image of frame 9 as a reference image. In S6, the image of decoded frame 100 is added to image memory 6.

Next, this is the case where frames 1 to 9 are normally decoded, frame 100 is decoded using frame 9 as a reference image and subsequently frame 101 is to be decoded. In this case, the order of input to the moving image reproduction device is L=9, M=100, N=101. This case corresponds to the “the third case” described above.

In S2 of FIG. 4, the relation is M−L=91 and the difference is other than one. Then, the result is NO. It is thus determined that there is one of a possibility of absence of an image between frames L and M and a possibility of occurrence of a decode error of the frame number of frame M, and the process proceeds to S8. In S8, in order to determine whether or not there is absence of an image between frames L and M (9 and 100), N−L is calculated. In this case, the relation is N−L=92 and the result is NO. It is thus determined that there is absence of an image between frames L and M. Image correction unit 5 is informed of this and the process proceeds to S10. The number of missing images is determined by calculating M−L−1. It is accordingly seen that the number of missing images is 90 and that frames 10 to 99 have to be replenished.

In S10, image correction unit 5 replicates the image displayed latest among images stored in image memory 6, and the missing image between frames L and M is replaced with the replicated image so as to replenish the missing image between frames Land M. In S10, in order to replenish the missing image of frame 10, image correction unit 5 first replicates and stores in image memory 6 the image of frame 9 which is displayed latest among images stored in image memory 6 and, in order to replenish the missing image of frame 11, image correction unit 5 replicates and stores in image memory 6 the image of frame 10 which is displayed latest among images stored in image memory 6. In this way, 90 images respectively of frames 10 to 99 are replenished and the process proceeds to S3. Any image that cannot be accommodated with the storage capacity of image memory 6 is successively displayed. Since image memory 6 can record four images, respective images of frames 97 to 100 are stored and held in image memory 6, and the frames to frame 96 are displayed.

In S3, reference image list generation unit 4 examines image memory 6 to generate a reference image list and the process proceeds to S4. In S4, decode abnormality detection unit 3 calculates N−M in order to determine whether or not there is a possibility of absence of an image between frames 100 and 101 (frames M and N). Since the result of the calculation is one thus the result of S4 is YES. It is thus determined that there is no possibility of absence of an image between frames M and N, and the process proceeds to S5. In S5, image decoding unit 2 decodes frame 101 (frame N) and the process proceeds to S6. In S6, the decoded frame N is stored in image memory 6 and output at a predetermined timing on an external display (not shown).

Next, this is the case where frames to frame 101 are normally decoded, and frame 102 is to be decoded now using frame 101 as a reference image. In this case, the order of input to the moving image reproduction device is L=100, M=101, N=102. This case corresponds to “the first case” described above. The process then proceeds to S2 where the relation M−L=1 is satisfied and the result is YES. It is thus determined that there is none of the possibility of absence of an image between frames L and M and the possibility of occurrence of a decode error of the frame number of frame M. In S4, the relation N−M=1 is satisfied and the result is YES. It is thus determined that there is no possibility of absence of an image between frames M and N and normal decoding is confirmed.

As seen from the above, even if any image is missing, image correction unit 5 replicates the image which is displayed latest among images stored in image memory 6, and the missing image between frames L and M is replaced with the replicated image to replenish the missing image between frames L and M. For replenishment of the missing image (S10 of FIG. 4) as described above, the image which is displayed latest among images decoded and stored in image memory 6 is replicated and the missing image between frames L and M is replaced with the replicated image so as to replenish the missing image. However, instead of the image which is displayed latest, the image which is closest to the missing image in terms of the order of display may be used.

Further, in the present embodiment, a decode abnormality is detected for the three successive frame numbers: L, M, N, a decode abnormality may be detected for the four successive frame numbers, for example, K, L, M, N (they are integers having the relation K<L<M<N). In this case, the step in S2 “M−L=1?” in which M−L is calculated of FIG. 4 performed for determining whether or not there is a possibility of absence of an image between frames L and M may be replaced with S2: “M−K=2?” in which M−K is calculated for determining whether or not there is a possibility of absence of an image between frames K and M. In S2, the result is NO and it is determined that there is a possibility of absence of an image. In this case, S8: “N−L=2?” in which N−L is calculated for determining whether or not there is absence of an image between frames L and M may be replaced with “N−K=3?” in which N−K is calculated for determining whether or not there is absence of an image between frames K and M. Thus, for three or more successive frame numbers as well, the decode abnormality can be detected.

Regarding the moving image reproduction device in the present embodiment, if transmitted encoded data includes a bit error or the like, only a part of the image is decoded and decoding of the remaining part could fail. In the case where only a part of frame M is decoded, frame M may be discarded and decoding of the image from frame N may be continued. Alternatively, the partial region where decoding of frame M fails may be replenished using the decoded region or decoded image of frame M, and the whole frame M is thus decoded and decoding of images from frame N may be continued. If the problem that only a part of an image is decoded occurs, the decoding process for images from the image for which the problem occurs does not fail, using any of the method according to which the image which is only partially decoded is discarded and the method according to which the partial region where decoding fails is replenished. In particular, when the method is used according to which the partial region where decoding fails is replenished, the quality of the reproduced image is further improved as compared with the case where the method is used according to which the decoded image is discarded.

As explained above, the moving image reproduction device in the present embodiment uses the frame number for detecting absence of an image. However, as long as the number of images that should be present between images can be detected by comparison, between different images, of a combination of at least one parameter unique to each image, the combination of the parameters may be used instead of the frame number.

### Second Embodiment

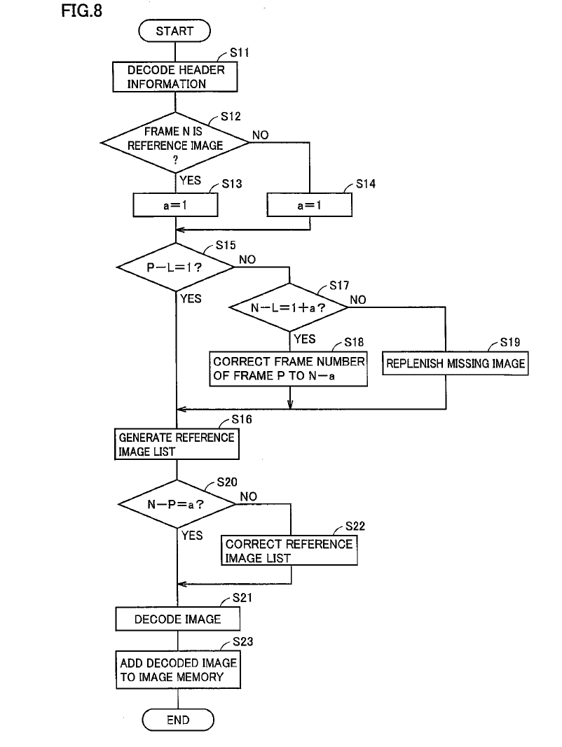

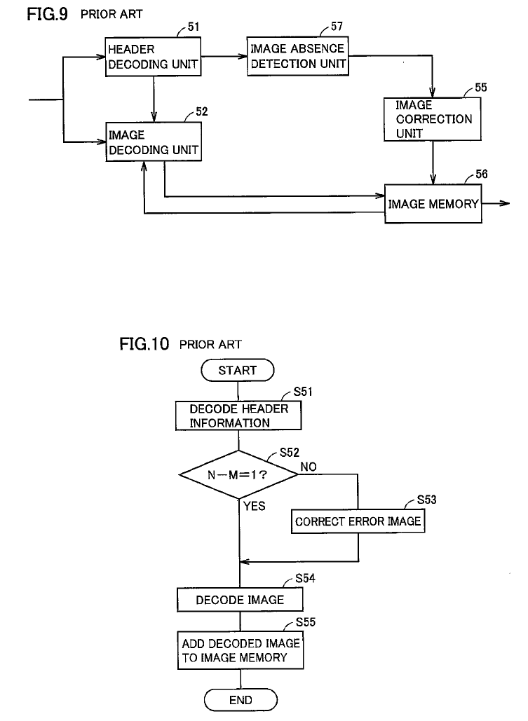

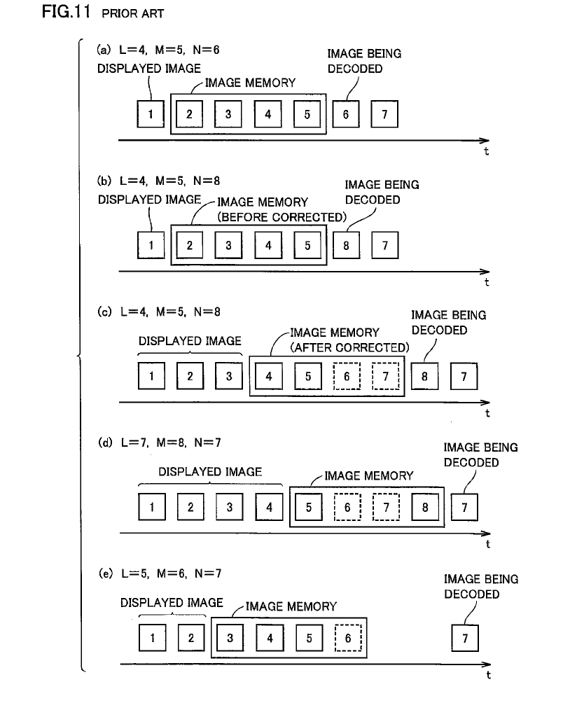

Next, a description will be given of a moving image reproduction device according to a second embodiment of the present invention. In the following description, as shown in FIG. 7, it is supposed that an image to be decoded (image being decoded) by the moving image reproduction device is frame N, an image which is decoded immediately before frame N (the image may be reference image or non-reference image) is frame P, and one of decoded reference images that is second closest to frame N in order of decoding, with respect to other decoded reference images, is frame L. The moving image reproduction device in the present embodiment differs from the moving image reproduction device in the first embodiment in that the frame number used for determining whether or not any image is missing is a parameter that increases in order of decoding reference images.

In FIG. 7, respective frames of reference images have frame number 4 (frame L), frame number 5 (frame M) and frame number 6, and the frame of a non-reference image has the same frame number as the frame number of the reference image that is decoded immediately before the non-reference image. For example, frames P and N are both non-reference images and have the same frame number 5 as the frame number 5 of reference image M decoded immediately before the non-reference image. Here, reference image refers to an image necessary for decoding another frame image decoded later, and it is determined in advance whether to use the image as a reference image or not. An example of the parameter that is used by the common moving image encoding method and that increases in order of decoding reference images is frame_num which is a syntax element defined by H.264/AVC.

The moving image reproduction device in the present embodiment is identical in configuration to moving image reproduction device 1000 in the first embodiment as shown in FIG. 1. The reference characters in FIG. 1 are used here as they are. Decode abnormality detection unit 3 holds respective frame numbers of frames L, M, N, P and, based on respective frame numbers of three frames L, P, N, detects whether or not an image is missing between frames L and P, whether or not there is a possibility of absence of an image between frames P and N, and whether or not a decoding error of the frame number of frame P occurs. Respective configurations of decode abnormality detection unit 3 and reference image list generation unit 4 in the second embodiment are also identical to respective configurations of decode abnormality detection unit 3 and reference image list generation unit 4 in the first embodiment and shown in FIGS. 2 and 3 respectively. The reference characters in FIGS. 2 and 3 are used here as they are.

Specifically, decode abnormality detection unit 3 detects whether or not there is an abnormality relating to a frame, based on the frame number corresponding to frame N (n-th frame) decoded by image decoding unit 2, the frame number corresponding to the (n−1)-th frame (frame P) decoded by image decoding unit 2 and the frame number corresponding to the reference image which is second closest to frame N (n-th frame) among reference images decoded by image decoding unit 2.

Here, the abnormality to be detected may be the abnormality that image memory 6 does not store a frame as a reference image to be used by image decoding unit 2 when image decoding unit 2 decodes frame N. The detected abnormality may be the abnormality that there is a missing frame. Further, the detected abnormality may be the abnormality that there is a decoded frame having an error of the frame number.

A description will be given of operation of the moving image reproduction device in the present embodiment based on FIG. 8. In the present embodiment, abnormality detection unit 3 detects the four cases, namely the fifth to eighth cases as described below, based on the determination as to whether or not there is absence of an image between frames L and P, whether or not there is a possibility of absence of an image between frames P and N, and whether or not there is occurrence of a decode error of the frame number of frame P. The value of variable “a” is 1 if frame N is a reference image and 0 if not.

Fifth case: The relations N−P=a and P−L=1 are satisfied and it is determined that there is no possibility of absence of an image between frames L and N.

Sixth case: N−P is any other than “a”, the relation P−L=1 is satisfied and it is determined that there is a possibility of absence of an image between frames P and N.

Seventh case: N−L is any other than 1+a, P−L is any other than one and it is determined that there is absence of an image between frames L and P.

Eighth case: the relation N−L=1+a is satisfied, P−L is any other than one and it is determined that there is occurrence of a decode error of the frame number of frame P.

Depending on the result of detection by decode abnormality detection unit 3, the operation of the moving image reproduction device in the present embodiment varies. In the following, operation according to each result of detection by decode abnormality detection unit 3 will be described in connection with a flow of a process.

In the fifth case, in S11, header decoding unit 1 decodes header information from input encoded data. The process then proceeds to S12 in which it is determined whether or not frame N is a reference image. In S12, when frame N is a reference image, the process proceeds to S13, and thus “a” is a=1. When frame N is not a reference image, the process proceeds to S14 and a is thus a=0. From S13, S14, the process proceeds to S15 in which decode abnormality detection unit 3 calculates P−L in order to determine whether or not there is a possibility of absence of an image between frames L and P. In the fifth case, the relation P−L=1 is satisfied and the result is YES. It is thus determined that there is none of the possibility of absence of an image between frames L and P and the possibility of a decode error of the frame number of frame P. The process then proceeds to S16, and the process of detecting whether or not there is absence of an image (S17) is not performed.

In S16, reference image list generation unit 4 examines image memory 6 to generate a reference image list, and the process proceeds to S20. In S20, decode abnormality detection unit 3 calculates N−P in order to determine whether or not there is a possibility of absence of an image between frames P and N. In the fifth case, there is the relation N−P=a and the result is YES. It is thus determined that there is no possibility of absence of an image and the process proceeds to S21. In S21, image decoding unit 2 decodes frame N and the process proceeds to S23. In S23, decoded frame N is stored in image memory 6 and displayed at a predetermined timing on an external display (not shown).

In the sixth case, in S11, header decoding unit 1 decodes header information from input encoded data. The process then proceeds to S12 in which it is determined whether or not frame N is a reference image. In S12, when frame N is a reference image, the process proceeds to S13 and thus “a” is a=1. When frame N is not a reference image, the process proceeds to S14 and thus “a” is a=0. From S13, S14, the process proceeds to S15 in which decode abnormality detection unit 3 calculates P−L in order to determine whether or not there is a possibility of absence of an image between frames L and P. In the sixth case, the relation P−L=1 is satisfied and thus the result is YES. It is thus determined there is none of the possibility of absence of an image between frames L and P and the possibility of occurrence of a decode error of the frame number in frame P. The process then proceeds to S16, while the process of detecting whether or not there is absence of an image (S17) is not performed.

In S16, reference image list generation unit 4 examines image memory 6 to generate reference image list 13, and the process proceeds to S20. In S20, decode abnormality detection unit 3 calculates N−P in order to determine whether or not there is a possibility of absence of an image between frames P and N. In the sixth case, N−P is any other than “a” and the result is NO. It is thus determined that there is a possibility of absence of an image, and the process proceeds to S22. In S22, reference image list generation unit 4 corrects reference image list 13. The method of correcting the reference image list in S22 is similar to the method of correcting (S7 in FIG. 4) the reference image list by the moving image reproduction device in the first embodiment. In the subsequent S21, image decoding unit 2 decodes frame N and the process proceeds to S23. In S23, decoded frame N is stored in image memory 6 and displayed at a predetermined timing on an external display (not shown).

In the seventh case, in S11, header decoding unit 1 decodes header information from input encoded data. Then, the process proceeds to S12 in which it is determined whether or not frame N is a reference image. In S12, when frame N is a reference image, the process proceeds to S13 and thus a=1. When frame N is not a reference image, the process proceeds to S14 and thus a=0. From S13, S14, the process proceeds to S15 in which decode abnormality detection unit 3 calculates P−L in order to determine whether or not there is a possibility of absence of an image between frames L and P. In the seventh case, P−L is any other than one and the result is NO. It is thus determined that there is any of the possibility of absence of an image between frames L and P and the possibility of occurrence of a decode error of the frame number of frame P. The process then proceeds to S17. In S17, N−L is calculated in order to determine whether or not there is absence of an image between frames L and P. In the seventh case, N−L is any other than 1+a. The result is thus NO. It is determined that there is absence of an image. Image correction unit 5 is informed of this and the process proceeds to S19. In S19, image correction unit 5 replicates the image which is displayed latest among images stored in image memory 6, and replaces the missing image between frames L and P with the replicated image to replenish the missing image between frames L and P, and the process proceeds to S16. Regarding the method of replenishing a missing image in S19, the moving image reproduction device of the present embodiment replenishes the missing image if the missing image is a reference image, while it does not replenish the missing image if the missing image is a non-reference image which is not a reference image, which is different from the first embodiment (S10 in FIG. 4). This will be described later.

In S16, reference image list generation unit 4 examines image memory 6 to generate reference image list 13, and the process proceeds to S20. In S20, decode abnormality detection unit 3 calculates N−P in order to determine whether or not there is a possibility of absence of an image between frames P and N. When there is the relation N−P=a, the result is YES. It is thus determined that there is no possibility of absence of an image between frames P and N, and the process proceeds to S21. When N−P is any other than a, the result is NO. It is thus determined that there is a possibility of absence of an image between frames P and N, and the process proceeds to S22. In S22, reference image list generation unit 4 corrects reference image list 13. The method of correcting the reference image list in S22 is similar to the method of correcting the reference image list (S7 in FIG. 4) by the moving image reproduction device in the first embodiment. In the subsequent S21, image decoding unit 2 decodes frame N and the process proceeds to S23. In S23, decoded frame N is stored in image memory 6 and displayed at a predetermined timing on an external display (not shown).

In the eighth case, in S11, header decoding unit 1 decodes header information from input encoded data. The process then proceeds to S12 in which it is determined whether or not frame N is a reference image. In S12, when frame N is a reference image, the process proceeds to S13 and thus a=1. When frame N is not a reference image, the process proceeds to S14 and thus a=0. From S13, S14, the process proceeds to S15 in which decode abnormality detection unit 3 calculates P−L in order to determine whether or not there is a possibility of absence of an image between frames L and P. In the eighth case, P−L is any other than one and the result is NO. It is thus determined that there is any of the possibility of absence of an image between frames L and P and the possibility of occurrence of a decode error of the frame number of frame P, and the process proceeds to S17. In S17, N−L is calculated in order to determine whether or not there is absence of an image between frames L and P. In the eighth case, there is the relation N−L=1+a and the result is YES. It is determined that no image between frames L and P is missing, and it is determined that there is occurrence of a decode error of the frame number of frame P. Image correction unit 5 is informed of this and the process proceeds to S18. In S18, image correction unit 5 changes the frame number of frame P to N−a. The process proceeds to S16.

In S16, reference image list generation unit 4 examines image memory 6 to generate reference image list 13, and the process proceeds to S20. In S20, decode abnormality detection unit 3 calculates N−P in order to determine whether or not there is a possibility of absence of an image between frames P and N. In S18, image correction unit 5 changes the frame number of frame P in image memory 6 to N−a and thus there is the relation N−P=a. In S20, the result is thus YES. It is determined that there is no possibility of absence of an image between frames P and N, and the process proceeds to S21. In S21, image decoding unit 2 decodes frame N and the process proceeds to S23. In S23, the decoded frame N is stored in image memory 6 and displayed at a predetermined timing on an external display (not shown).

In the present embodiment, the method of correcting the reference image list in S22 of FIG. 8 is similar to the method of correcting the reference image list (S7 in FIG. 4) by the moving image reproduction device in the first embodiment. As to the replenishment method for the missing image in S19 of FIG. 8, however, the method is different from the replenishment method for the missing image (S10 in FIG. 4) used by the moving image reproduction device in the first embodiment. The difference will be described in detail below.

Regarding the moving image reproduction device in the present embodiment, replenishment is performed when the missing image is a reference image, while replenishment is not performed when the missing image is a non-reference image which is not a reference image. According to the replenishment method for the missing image in S19 of FIG. 8, the number of reference images other than frames L, P between frames L and P is P−L−1 in the case where frame P is a reference image, and is P−L in the case where frame P is a non-reference image which is not a reference image. Image correction unit 5 replenishes missing reference images of the number known from the aforementioned number by replicating the image which is displayed latest in the reference image memory, and record the replicated image in the image memory.

The reason why replenishment of any missing non-reference image is unnecessary is as follows. Regarding the moving image reproduction device in the present embodiment, in the case where a non-reference image with an output timing corresponding to a certain time is not in the image memory, the image displayed immediately before is kept displayed. In other words, the missing non-reference image is replaced with the image which is displayed immediately before the image at the display timing. Therefore, it is unnecessary to replenish the missing non-reference image in the image memory. In contrast, for the reference image, the reference image is used when another image is decoded, the reference image has to be replenished in the image memory.

With the above-described operation, the moving image reproduction device in the present embodiment can prevent deterioration of image quality due to absence of an image and a decode error of the frame number, in the case where the frame number increases in order of decoding of the reference images.

Like the moving image reproduction device in the first embodiment, the moving image reproduction device in the present embodiment may continue, when only a part of frame M is decoded and decoding of the remaining part fails, to decode images from frame N without recording the partially decoded frame M in the image memory, and discarding the part of frame M. Alternatively, the device may replenish the part of frame M where decoding fails by using the decoded region of frame M or a decoded image, so as to decode the whole frame M, and continue to decode the subsequent images from frame M.

As described above, respective frame numbers of a plurality of decoded images that have been decoded successively immediately before a frame image to be decoded are used to determine whether there is a possibility of absence of an image among the decoded images or possibility of an error of the frame number itself of the image. When it is determined that there is one of the possibilities, the frame number of the image to be decoded and the frame number of a decoded reference image which is decoded earlier relative to frame numbers of the plurality of images decoded immediately before the image to be decoded are used to determine whether there is absence of an image in the decoded images or an error of the frame number itself. According to the result of the determination, the missing image is replenished or the error of the frame number itself is corrected. After this, a reference image list is generated for determining the storage address in image memory 6 of a plurality of reference images each as held, and the image to be decoded is decoded.

When it is determined that the frame number corresponding to a frame image to be decoded by image decoding unit 2 is an incorrect frame number which is not the frame number allocated to each frame image in the order according to a predetermined rule, it is determined whether or not the reference image determined by the incorrect frame number is included in image memory 6. If not, a decoded image stored in image memory 6 is used as a reference image instead and accordingly the image to be decoded is decoded by image decoding unit 2.

### SUMMARY

The technical ideas explained in connection with the embodiments are summarized as follows.

(1) Possible causes of an error of the frame number which is necessary for successively decoding images include data garbling of the frame number itself in addition to absence of an encoded image. If it is erroneously determined that the cause is absence of image data, despite the fact that the actual cause is data garbling of the frame number itself and then image data of the number which is determined as the number of missing image data are replenished, the replenishment is performed while the replenishment is unnecessary. Accordingly, due to display of the replenished images, the order of display of the subsequent image data is displaced backward. As a result, a first defect: images cannot be displayed in the normal order and display of other images is delayed, arises.

Further, when an image is decoded, a plurality of reference image data having already been decoded and present near the image to be decoded are referenced. At this time, the unnecessarily replenished image data is present between the image to be decoded and neighboring decoded image to be referenced. Thus, when any neighboring image data is to be referenced, the image data could have been expelled from the image memory and displayed. As a result, a second defect: neighboring image data to be referenced is absent and it cannot be referenced, arises.

(2) In order to solve these two problems, the function may be provided of determining whether the cause of an error of the frame number is actually absence of image data or garble of data of the frame number itself instead, and an appropriate control process adapted to the cause may be performed, according to the result of the determination.

Regarding the determination of the cause of an error of the frame number, it has been found that there is the following law of nature. The law of nature is specifically as follows. In the case where the cause is absence of image data, the frame number of image data subsequent to the frame number which is an abnormal number is, in most cases, larger by at least three than the frame number of image data preceding the abnormal frame number. In the case where the cause is data garbling of the frame number itself, the frame number of image data subsequent to the abnormal frame number is, in most cases, larger by two (two added) than the frame number of the image data preceding the abnormal frame number. The law of nature is based on an empirical rule: successive data garbling hardly occurs stochastically, namely it hardly occurs that data itself of the frame number garbles due to noise or the like and both of respective frame numbers of the immediately preceding and succeeding image data also garble due to noise.

(3) Thus, the present invention can use the above-described law of nature to check consistency between respective frame numbers of at least three adjacent image data and thereby determine whether the cause of an error of the frame number is absence of image data or data garbling of the frame number itself.

(4) In accordance with the law of nature as described above, however, in the case where the frame number of image data to be decoded in a certain place in order of decoding is not a serial number, determination of the reason why the number is not a serial number requires at least three frame numbers that are the frame number of this image data and respective frame numbers of its preceding and succeeding image data. Thus, the frame number of the image data to be decoded after the aforementioned image data to be decoded is necessary. Therefore, at the stage of decoding the image data having the erroneous frame number, the cause of the error of the frame number cannot be determined with absolute certainty.

According to the present invention, regardless of the cause of the error of the frame number of the image data, without replenishment of image data between the erroneous frame number and the frame number of image data decoded immediately before the image data of the erroneous frame number, the image data of the erroneous frame number is decoded first of all, in order to solve the first defect and the second defect as described above.

At the stage of decoding the subsequent image data, the frame number of this image data is obtained. Thus, the three frame numbers are now known and, at this time, the cause of the error of the frame number of decoded image data is determined. In other words, a comparison is made between the frame number of the frame image to be decoded after the erroneous frame number for which the image data is decoded first of all and the frame number of the image which has already been decoded other than the erroneous frame number, and it is determined whether or not the frame number to be decoded follows a predetermined rule (serial number). If the frame number does not follow the rule, it is determined that the cause of the error of the frame number is absence of a frame image. When the frame number follows the predetermined rule, it is determined that the cause of the error of the frame number is data garbling of the frame number itself.

According to the result of the determination, if image data is actually absent, the absent image data is now replenished at this stage. In contrast, if the cause of the error of the frame number is data garbling of the frame data, unnecessary replenishment of image data is never performed.

However, in the case where the image data of the erroneous frame number (which is not serial number) is decoded first of all, reference image data determined by the erroneous frame number may not be present in the image memory in some cases. A resultant another disadvantage could be that the reference image cannot be obtained and the device fails. Accordingly, the present invention alternatively uses an image in the image memory instead of the necessary reference image. In consideration of the case where the cause of an abnormality is absence of image data, instead of the reference image which is not in the image memory, the image which is displayed latest in order of display among decoded images stored in the image memory is used, or the image which is closest in order of display to the reference image if the reference image, which is in fact determined as absent in the image memory, is in the image memory, is used among decoded images stored in the image memory.

In the case where an error of the frame number occurs and the cause of the error is absence of an image, if no replenishment is performed and decoding is performed as specified, the reference image could not be obtained and the decoder could fail. Therefore, according to the conventional art, as soon as the error of the frame number is found, it is determined that the cause is absence of an image, and the image is replenished to allow decoding to be continued. In contrast, according to the present invention as described in connection with the embodiments, the reference image list is used to decode the image having the erroneous frame number, without replenishing the image. Thus, even if any image is absent, the decoder never fails. Further, even if the frame number garbles, rewriting of the image memory resultant from the replenishment is not performed. Therefore, shortage of reference images used for decoding subsequent images does not occur.

It should be construed that the embodiments herein disclosed are presented by way of illustration, not limitation, in all respects. The scope of the invention is defined by the claims, not by the description above, and is intended to include all modifications within equivalent in meaning and scope to the claims.

1. A moving image reproduction device reproducing a moving image composed of a plurality of frames by decoding encoded data of the moving image, comprising:
header information decoding means for successively decoding header information of said plurality of frames each from said encoded data;
frame decoding means for successively decoding said plurality of frames;
storage means for allowing successive storage of a predetermined number of decoded frames that are decoded by said frame decoding means;
abnormality detection means for detecting whether or not there is an abnormality relating to a frame, based on at least two pieces of said header information including said header information of an n (natural number of at least two)-th frame that are decoded by said header information decoding means;
list generation means for generating a reference list for allowing said frame decoding means to access a decoded frame stored in said storage means and used as a reference image, by associating said header information of each of at least one said decoded frame stored in said storage means with a storage address of each of said at least one decoded frame; and
list correction means for correcting said reference list when the abnormality detected by said abnormality detection means is a predetermined abnormality, wherein
when said n-th frame is a frame decoded using another frame said frame decoding means decodes said n-th frame using a decoded frame that is stored in said storage means and used as said reference image and that is accessible by means of said reference list when said n-th frame is decoded, based on said header information of said n-th frame.

2. The moving image reproduction device according to claim 1, wherein
said plurality of frames are in order of being decoded by said frame decoding means.

3. The moving image reproduction device according to claim 1, wherein
said header information includes a frame number for identifying a frame, and
said list generation means generates the reference list for allowing said frame decoding means to access a decoded frame stored in said storage means and used as a reference image, by associating the frame number of each of said at least one decoded frame stored in said storage means with the storage address of each of said at least one decoded frame.

4. The moving image reproduction device according to claim 1, wherein
said header information includes a frame number for identifying a frame,
said predetermined abnormality is an abnormality that a decoded frame used as said reference image by said frame decoding means when said frame decoding means decodes said n-th frame is not stored in said storage means, and
said list correction means corrects said reference list, when the abnormality detected by said abnormality detection means is said predetermined abnormality, by associating the frame number of the decoded frame used as said reference image with the storage address of a frame that is included in said at least one decoded frame stored in said storage means and that is used latest for display.

5. The moving image reproduction device according to claim 1, wherein
said header information includes a frame number for identifying a frame,
said predetermined abnormality is an abnormality that a decoded frame used as said reference image by said frame decoding means when said frame decoding means decodes said n-th frame is not stored in said storage means, and
said list correction means corrects said reference list, when the abnormality detected by said abnormality detection means is said predetermined abnormality, by associating the frame number of the decoded frame used as said reference image with the storage address of a frame that is included in said at least one decoded frame stored in said storage means and that is closest to the decoded frame used as said reference image in terms of order of use for display.

6. The moving image reproduction device according to claim 1, wherein
said header information includes a frame number for identifying a frame,
said abnormality detection means determines whether or not there is a missing frame based on three frame numbers corresponding respectively to at least three successive frames including said n-th frame, and
said moving image reproduction device further comprises replenishment means for replenishing, when said abnormality detection means determines there is a missing frame, the missing frame by replicating a frame that is included in said at least one decoded frame stored in said storage means and used as said reference image by said frame decoding means and that is used latest for display.

7. The moving image reproduction device according to claim 1, wherein
said header information includes a frame number for identifying a frame,
said abnormality detection means determines whether or not there is a missing frame based on three frame numbers corresponding respectively to at least three successive frames including said n-th frame, and
when said abnormality detection means determines there is a missing frame, said replenishment means replenishes said missing frame by replicating a frame that is included in said at least one decoded frame stored in said storage means and used as said reference image by said frame decoding means and that is closest to the missing frame in terms of order of use for display.

8. The moving image reproduction device according to claim 1, wherein
said header information includes a frame number for identifying a frame, and
said abnormality detection means determines, based on three frame numbers corresponding respectively to at least three successive frames including said n-th frame, whether or not there is a decoded frame among said three frames that is stored in said storage means and having an erroneous frame number.

9. The moving image reproduction device according to claim 8, further comprising number correction means for correcting, when said abnormality detection means determines that there is said decoded frame having the erroneous frame number, the erroneous frame number of said decoded frame, based on the frame number of a frame without an error among said three frames.

10. The moving image reproduction device according to claim 1, wherein
said header information includes a frame number for identifying a frame,
said plurality of frames include a plurality of reference frames used as said reference image by said frame decoding means, and
said abnormality detection means detects whether or not there is an abnormality relating to a frame, based on the frame number corresponding to said n-th frame decoded by said frame decoding means, the frame number corresponding to an th frame decoded by said frame decoding means and the frame number corresponding to a reference frame second closest to said n-th frame, among a plurality of said reference frames decoded by said frame decoding means.

11. The moving image reproduction device according to claim 10, wherein
the abnormality detected by said abnormality detection means is an abnormality that a decoded frame used as said reference image by said frame decoding means when said frame decoding means decodes said n-th frame is not stored in said storage means, and
when there is the abnormality that a decoded frame used as said reference image is not stored in said storage means, said list correction means corrects said reference list by associating the frame number of the decoded frame used as said reference image with a storage address of a frame that is included in said at least one decoded frame stored in said storage means and that is used latest for display.

12. The moving image reproduction device according to claim 10, wherein
the abnormality detected by said abnormality detection means is an abnormality that there is a missing frame, and
said moving image reproduction device further comprises replenishment means for replenishing, when said abnormality detection means determines there is a missing frame, the missing frame by replicating a frame that is included in said at least one decoded frame stored in said storage means and used as said reference image by said frame decoding means, and that is used latest for display.

13. The moving image reproduction device according to claim 10, wherein
the abnormality detected by said abnormality detection means is an abnormality that there is a decoded frame having an erroneous frame number, and
said moving image reproduction device further comprises number correction means for correcting, when there is said decoded frame having the erroneous frame number, the erroneous frame number of said decoded frame based on the frame number of a frame without error, among the frame number of said n-th frame, the frame number of said th frame and the frame number of the reference frame that is second closest to said n-th frame.
